(19) United States
(12) Patent Application Publication
(10) Pub. No.: US 2025/0354017 A1
(43) Pub. Date: Nov. 20, 2025

(54) ANTI-FOGGING AND BACTERIA-RESISTANT LIQUID SILICONE RUBBER ADDITIVES AND THE APPLICATIONS THEREOF

(71) Applicant: Nano and Advanced Materials Institute Limited, Hong Kong (HK)

(72) Inventors: Xianqiao LIU, Hong Kong (HK); Suqing TAN, Hong Kong (HK); Wei KONG, Hong Kong (HK); Tsz Yan LAM, Hong Kong (HK)

(21) Appl. No.: 18/665,626

(22) Filed: May 16, 2024

(51) Int. Cl. C09D 5/16; C08G 77/18; C08G 77/38; C08G 77/46; C09D 5/14; C09D 183/04

(52) U.S. Cl. CPC C09D 5/1675; C08G 77/18; C08G 77/38; C08G 77/46; C09D 5/14; C09D 183/04

(57) ABSTRACT

An anti-fogging and bacteria-resistant liquid silicone rubber additive composition is provided. This composition includes 20-30 wt. % of a silicone network elastomer, 30-70 wt. % of an anti-fogging network-forming surfactant, and 4-10 wt. % of a Si—H reactive crosslinker. The anti-fogging network-forming surfactant contains hydrophilic and hydrophobic components, allowing it to integrate with the silicone network elastomer to form a partial interpenetrative network. The Si—H reactive crosslinker facilitates crosslinking of the surfactant with the elastomer, further enhancing the composition's anti-fogging and bacteria-resistant properties.

### FIELD OF THE INVENTION

The present invention generally relates to silicone-based materials. More specifically the present invention relates to anti-fogging and bacteria resistant liquid silicone rubber additives.

### BACKGROUND OF THE INVENTION

Fog forms when the air temperature approaches the dew point, resulting in condensation of water vapor into tiny droplets. This phenomenon occurs under conditions of high humidity, precipitation, or temperature gradients, leading to reduced visibility and potential hazards, especially on surfaces such as cold displays, mirrors, safety glasses, and medical devices. The impairment caused by fogging can range from diminished aesthetics to compromised reaction times or complete loss of visibility.

Current methods for mitigating fogging typically involve applying surface coatings to substrates using chemical solution deposition techniques. These processes often require labor-intensive surface preparation steps, such as dip coating or spray coating, and the use of excess solvents for dispersing monomers, curing agents, and surfactants.

For instance, traditional anti-fog coatings face several technical limitations that hinder their effectiveness and durability. One prominent issue is the susceptibility to mechanical wear and abrasion, particularly in high-traffic areas or industrial environments where surfaces are subjected to frequent handling or cleaning. Additionally, poor wash durability is a common concern, as conventional coatings may degrade or lose their anti-fog properties after repeated exposure to water or cleaning agents. Environmental factors, such as UV radiation or extreme temperatures, can also contribute to the degradation of anti-fog coatings, leading to diminished performance over time. Moreover, the transparency of coated surfaces may be compromised, resulting in obscured vision or reduced optical clarity.

Therefore, these technical challenges underscore the need for approaches to anti-fogging technology that can address these issues and provide long-lasting, reliable fog prevention across a wide range of applications. The present invention addresses this need.

### SUMMARY OF THE INVENTION

It is an objective of the present invention to provide compound, material, or method to solve the aforementioned technical problems.

In accordance with a first aspect of the present invention, an anti-fogging and bacteria-resistant liquid silicone rubber additive composition is provided. Specifically, the composition includes 20-30 wt. % of a silicone network elastomer; 30-70 wt. % of an anti-fogging network-forming surfactant; and 4-10 wt. % of a Si—H reactive crosslinker including multiple OH functionality.

In accordance with one embodiment of the present invention, the anti-fogging network-forming surfactant includes a hydrophilic component comprising hydrophilic groups, and a carbon-based and/or silicone-based hydrophobic component such that the surfactant is capable of integrating with the silicone network elastomer to form a partial interpenetrative network.

In accordance with another embodiment of the present invention, the anti-fogging network-forming surfactant is Si—H reactive so as to be crosslinked and enmeshed with the silicone network elastomer by the Si—H reactive crosslinker, forming the partial interpenetrative network.

In accordance with one embodiment of the present invention, the anti-fogging network-forming surfactant is selected from dimethylsiloxane-ethylene oxide block copolymer, polyglycerol, ethylene oxide or combinations thereof; and the hydrophilic groups are selected from polyhydroxyl group, polyethylene oxide group or combinations thereof.

In accordance with one embodiment of the present invention, the silicone network elastomer is a silicon or carbon network elastomer crosslinked with polyglycerol chains and/or polyether chains, enhancing the compatibility of the elastomer with a silicone matrix.

In accordance with one embodiment of the present invention, the silicone network elastomer is to provide a scaffold to capture the anti-fogging network-forming surfactant so that the migration rate of the anti-fogging network-forming surfactant is reduced, achieving a durable anti-fogging effect against washing, rubbing and increased temperature.

In accordance with one embodiment of the present invention, the silicone network elastomer is selected from cetyl diglyceryl tris(trimethylsiloxy)silylethyl dimethicone, polyglycerin-10, dimethicone (and) dimethicone/polyglycerin-3 crosspolymer, (hydroxypropyleneoxypropyl)methylsiloxane-dimethylsiloxane copolymer, cyclopentasiloxane (and) dimethicone/PEG-10/15 crosspolymer, or polyglyceryl-3 polydimethylsiloxyethyl dimethicone.

In accordance with one embodiment of the present invention, the Si—H reactive crosslinker is selected from sorbitol, maltitol, isomalt, galactitol, mannitol, xylitol, sucrose, DMPA, PEAE, pentaerythritol or any combination thereof.

In accordance with a second aspect of the present invention, a method of preparing the aforementioned anti-fogging and bacteria-resistant liquid silicone rubber additive composition is introduced. Particularly, the method encompasses the steps of: mixing the silicone network elastomer with the anti-fogging network-forming surfactant and the Si—H reactive crosslinker in a ratio of 20-30%, 30-70% and 4-10% (wt. %), respectively, to obtain a mixture; subjecting the mixture to a reaction process to facilitate crosslinking and incorporation of the components; and isolating and purifying the resulting anti-fogging and bacteria-resistant liquid silicone rubber additive composition.

In accordance with one embodiment of the present invention, the reaction process includes heating, stirring, or ultrasonic treatment to ensure thorough mixing and homogeneous distribution of the components within the mixture.

In accordance with a third aspect of the present invention, a method of fabricating an anti-fogging, antibacterial and transparent liquid silicone rubber film is provided. The method includes: adding the aforementioned anti-fogging and bacteria-resistant liquid silicone rubber additive composition to a transparent liquid silicone rubber precursor to obtain a mixture; removing air bubbles from the mixture; and vulcanizing the mixture for film making to obtain an anti-fogging, antibacterial and transparent liquid silicone rubber film.

In accordance with one embodiment of the present invention, the step of vulcanizing migrates hydrophilic groups of the hydrophilic component toward the surface of the film to lower the film's surface tension.

In accordance with one embodiment of the present invention, the anti-fogging, antibacterial and transparent liquid silicone rubber film has a bacterial adherence reducing rate ranging from 95% to 99% and possesses food contact safety.

In accordance with one embodiment of the present invention, the surface tension of the film is reduced to that the film has a water contact angle ranging from 60 to 65 degrees.

In accordance with one embodiment of the present invention, the step of vulcanizing is conducted at a temperature ranging from 140 to 250° C. for a duration of 10 seconds to 180 seconds, ensuring optimal cross-linking and incorporation of the anti-fogging network-forming surfactant.

In accordance with a fourth aspect of the present invention, a silicone rubber film produced using the aforementioned anti-fogging and bacteria-resistant liquid silicone rubber additive composition is present. Particularly, the film exhibits durable anti-fogging and antibacterial properties, making it suitable for applications requiring high transparency, hygiene, and visibility maintenance.

In accordance with one embodiment of the present invention, the applications include medical devices, food packaging, and optical lenses.

### BRIEF DESCRIPTION OF THE DRAWING

Embodiments of the invention are described in more details hereinafter with reference to the drawing, in which:

FIG. 1 depicts the anti-fogging effects and endurability of the anti-fogging, antibacterial and transparent liquid silicone rubber film samples.

### DETAILED DESCRIPTION

In the following description, compositions, materials, and/or methods of increasing anti-fogging and bacteria-resistant ability in silicone-based materials and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The present liquid silicone rubber additive composition includes a silicone network elastomer, an anti-fogging network-forming surfactant and a multi-OH crosslinking agent, ensuring compatibility with various types of liquid silicone rubber. The resulting silicone-based materials exhibit high wash durability, excellent transparency, and resistance to bacterial adhesion. Furthermore, the additive can be seamlessly integrated into existing manufacturing processes such as injection molding and compression molding, enabling the production of anti-fog silicone-based materials at a competitive cost.

In accordance with a first aspect of the present invention, an anti-fogging and bacteria-resistant liquid silicone rubber additive composition is provided. This composition includes 20-30 wt. % of a silicone network elastomer, 30-70 wt. % of an anti-fogging network-forming surfactant, and 4-10 wt. % of a Si—H reactive crosslinker. The anti-fogging network-forming surfactant is designed to include a hydrophilic component with hydrophilic groups, as well as a carbon-based and/or silicone-based hydrophobic component. This unique composition enables the surfactant to integrate with the silicone network elastomer, forming a partial interpenetrative network. Importantly, the anti-fogging network-forming surfactant is Si—H reactive, allowing it to be crosslinked and enmeshed with the silicone network elastomer by the Si—H reactive crosslinker, thereby forming the partial interpenetrative network.

Furthermore, the composition can be tailored to include specific types of anti-fogging network-forming surfactants and hydrophilic groups. For instance, suitable anti-fogging network-forming surfactants may include dimethylsiloxane-ethylene oxide block copolymer, polyglycerol, or ethylene oxide, while hydrophilic groups may consist of polyhydroxyl groups, polyethylene oxide groups, or combinations thereof.

Additionally, the silicone network elastomer plays a crucial role in enhancing the compatibility of the composition with a silicone matrix. This elastomer, which can be a silicon or carbon network elastomer crosslinked with polyglycerol chains and/or polyether chains, serves as a scaffold to capture the anti-fogging network-forming surfactant. By doing so, it reduces the migration rate of the surfactant, thereby achieving a durable anti-fogging effect against washing, rubbing, and increased temperature.

Several specific examples of silicone network elastomers are provided, including cetyl diglyceryl tris(trimethylsiloxy)silylethyl dimethicone, polyglycerin-10, dimethicone (and) dimethicone/polyglycerin-3 crosspolymer, (hydroxypropyleneoxypropyl)methylsiloxane-dimethylsiloxane copolymer, cyclopentasiloxane (and) dimethicone/PEG-10/15 crosspolymer, and polyglyceryl-3 polydimethylsiloxyethyl dimethicone.

The Si—H reactive crosslinker, chosen from options such as sorbitol, maltitol, isomalt, galactitol, mannitol, xylitol, sucrose, DMPA, PEAE, pentaerythritol, or any combination thereof, facilitates the crosslinking process and incorporation of the anti-fogging network-forming surfactant into the silicone network elastomer. This results in the formation of the desired partial interpenetrative network, ensuring the effectiveness and durability of the anti-fogging properties in various applications.

In accordance with a second aspect of the present invention, a method of preparing the aforementioned anti-fogging and bacteria-resistant liquid silicone rubber additive composition is introduced.

This method involves several steps to ensure the effective integration of the silicone network elastomer, the anti-fogging network-forming surfactant, and the Si—H reactive crosslinker. Initially, these components are mixed together in a predetermined ratio, ensuring proper balance and compatibility among them. The ratio may vary depending on specific formulation requirements and desired properties of the resulting composition; in one embodiment, it is in a ratio of 20-30%, 30-70% and 4-10% (wt. %), respectively. Subsequently, the mixture undergoes a reaction process aimed at facilitating crosslinking and incorporation of the components. This reaction process may involve various techniques such as heating, stirring, or ultrasonic treatment to ensure thorough mixing and homogeneous distribution of the components within the composition. Importantly, these steps achieve uniformity and consistency in the final product, thereby enhancing its anti-fogging and bacteria-resistant properties.

Following the completion of the reaction process, the resulting anti-fogging and bacteria-resistant liquid silicone rubber additive composition is isolated and purified. This purification step is essential for removing any impurities or by-products that may have formed during the reaction process, thereby ensuring the quality and purity of the final composition. The isolation and purification process may involve filtration, centrifugation, or other suitable techniques known in the art. Once isolated and purified, the composition is ready for further processing or incorporation into silicone-based materials for various applications requiring anti-fogging and bacteria-resistant properties.

In accordance with a third aspect of the present invention, a method for fabricating an anti-fogging, antibacterial, and transparent liquid silicone film is present. This method involves several steps to ensure the effective integration of the anti-fogging and bacteria-resistant liquid silicone rubber additive composition into a transparent liquid silicone precursor. Initially, the aforementioned anti-fogging and bacteria-resistant liquid silicone rubber additive composition is added to the transparent liquid silicone rubber precursor, resulting in the formation of a homogeneous mixture. Care is taken to ensure thorough mixing of the composition to achieve uniform distribution of the anti-fogging agents throughout the mixture. Subsequently, air bubbles present in the mixture are removed to prevent any defects in the final film.

Following the removal of air bubbles, the mixture is subjected to vulcanization to initiate the curing process and form the anti-fogging, antibacterial, and transparent liquid silicone rubber film. During vulcanization, the hydrophilic groups of the hydrophilic component within the anti-fogging network-forming surfactant migrate toward the surface of the film. This migration of hydrophilic groups reduces the film's surface tension, thereby enhancing its anti-fogging properties. The vulcanization process may be carried out at temperatures ranging from 140 to 250° C. for a duration of 10 seconds to 180 seconds. These conditions ensure optimal cross-linking and incorporation of the anti-fogging network-forming surfactant into the silicone matrix, resulting in a durable and effective anti-fogging film.

The resulting anti-fogging, antibacterial, and transparent liquid silicone rubber film exhibits exceptional properties, including a bacterial adherence reducing rate ranging from 95% to 99% and food contact safety. Additionally, the surface tension of the film is reduced to achieve a water contact angle ranging from 60 to 65 degrees, further enhancing its anti-fogging capabilities. These properties make the film suitable for a wide range of applications, including medical devices, optical lenses, and food packing, where anti-fogging and antibacterial properties are desired.

It is worth noting that the anti-fogging and bacteria-resistant liquid silicone rubber additive composition is compatible with both addition cure silicone and high consistency elastomeric silicone. Importantly, this compatibility is achieved without the need for surface modification; instead, it utilizes a built-in method through the addition of the additive. The composition does not require additional curing or hardening agents. Instead, it relies on the anti-fogging network-forming surfactant to create a partial interpenetrative hydrophilic network with the silicone network elastomer. This not only accelerates the curing rate but also reduces the migration rate of the anti-fog agents, resulting in a durable, long-lasting anti-fog effect while enhancing the film's hardness.

The additive is incorporated at an approximate level of <5 parts per hundred rubber (phr). The resulting anti-fog films demonstrate exceptional durability, maintaining an anti-fog effect of grade 2 or better after undergoing at least 100 washing cycles, as per the industrial standard (GB T 31726, 60° C., 15 min). These fabricated films also boast low haze (<10%) and high light transmittance (>90%) when measured at a thickness of 0.8 mm. Furthermore, they exhibit no compromise in mechanical performance and retain excellent transparency. The anti-fog films have also been certified for food contact safety in compliance with FDA and EU regulations, and has successfully passed bacteria repellency tests (ASTM E3371) conducted by SGS.

Therefore, the present invention further encompasses a silicone film produced using the aforementioned anti-fogging and bacteria-resistant liquid silicone rubber additive composition. This silicone film is distinguished by its exceptional durability and effectiveness in preventing fogging and inhibiting bacterial growth, thereby rendering it suitable for a wide range of applications requiring high transparency, hygiene, and visibility maintenance.

In particular, the silicone film exhibits robust anti-fogging and antibacterial properties, ensuring long-lasting performance even under challenging environmental conditions. These properties make the film highly desirable for various applications, including but not limited to medical devices, food packaging, and optical lenses. In medical settings, the film can be utilized to coat surgical instruments, medical equipment, and prosthetic devices, where maintaining visibility and cleanliness are paramount for patient safety and infection control.

Similarly, in food packaging applications, the silicone film provides an effective barrier against fogging, ensuring clear visibility of packaged products while maintaining hygiene standards. Additionally, the antibacterial properties of the film help prevent microbial contamination, thereby extending the shelf life of perishable goods and enhancing food safety.

Furthermore, in optical lens applications, such as eyeglasses, camera lenses, and protective goggles, the silicone film offers superior anti-fogging performance, allowing users to maintain clear vision even in humid or temperature-varying environments. The film's antibacterial properties further contribute to maintaining cleanliness and hygiene, particularly in settings where multiple users may come into contact with the lenses.

Overall, the silicone film produced using the anti-fogging and bacteria-resistant liquid silicone rubber additive composition represents a significant advancement in materials technology, offering enhanced performance and versatility for a wide range of industrial and consumer applications.

### EXAMPLE

### Example 1. Screening the Anti-Fogging Network-Forming Surfactants of the Additive Compositions

The development of anti-fogging liquid silicone rubber (LSR) films begins with the formulation of the anti-fog additive. Various categories of potential anti-fogging network-forming surfactants are screened based on their hydrophilic component (polyhydroxyl, polyethylene oxide), hydrophobic component (carbon-based, silicone based), and reactive functional group (vinyl, silane). It is determined that compounds containing abundant hydroxyl groups (—OH) and polyethylene oxide (—C—C—O—) exhibit superior anti-fogging performance.

For instance, polyglycerol, dimethyl siloxane-ethylene oxide block copolymer and ethylene oxide show strong effects in anti-fogging. Therefore, three anti-fogging and bacteria-resistant liquid silicone rubber additive composition sample are prepared. The components of them are listed in Table 1.

TABLE 1
The components of additive composition samples

| | | | Si—H |
|---|---|---|---|
| Sample | | Anti-fogging network- | reactive |
| No. | Silicone network elastomer | forming surfactant | crosslinker |
| Sample 1 | Cetyl diglyceryl | Dimethylsiloxane-(60- | Glycerol |
| | tris(trimethylsiloxy)silylethyl | 70% ethylene oxide) | |
| | dimethicone | block polymer | |
| Sample 2 | Cyclopentasiloxane (and) | Dimethylsiloxane-(60- | Glycerol |
| | dimethicone/PEG-10/15 | 70% ethylene oxide) | |
| | crosspolymer | block polymer | |
| Sample 3 | Polyglyceryl-3 | Dimethylsiloxane-(60- | Glycerol |
| | polydimethylsiloxyethyl | 70% ethylene oxide) | |
| | dimethicone | block polymer | |

In some embodiments, the addition amount of each component is in a mixing ratio of 2:4:1 (silicone network elastomer: anti-fogging network-forming surfactant: Si—H reactive crosslinker).

### Example 2. The Fabrication of Anti-Fogging, Antibacterial and Transparent Liquid Silicone Rubber Films

Briefly, the process involves incorporating the anti-fogging and bacteria-resistant liquid silicone rubber additive composition into high transparency liquid silicone rubber (LSR), followed by thorough mixing and degassing to eliminate air bubbles. Subsequently, vulcanization is carried out to produce an anti-fog LSR film (AFLSR).

During the vulcanization process, the hydrophilic segments of the AFLSR agents migrate to the surfaces of the AFLSR films, imparting an immediate anti-fogging effect by reducing the surface tension of the films. This reduction in surface tension results in the formation of thin water layers on the film surfaces rather than individual water droplets.

Utilizing sample 1-3 (the addition amount is 3-5 parts phr), three AFLSR film sample 1-3 are obtained.

### Example 3. The Anti-Fogging Effect, Light Transmittance, and the Antibacterial Activity of the Fabricated Anti-Fog Films

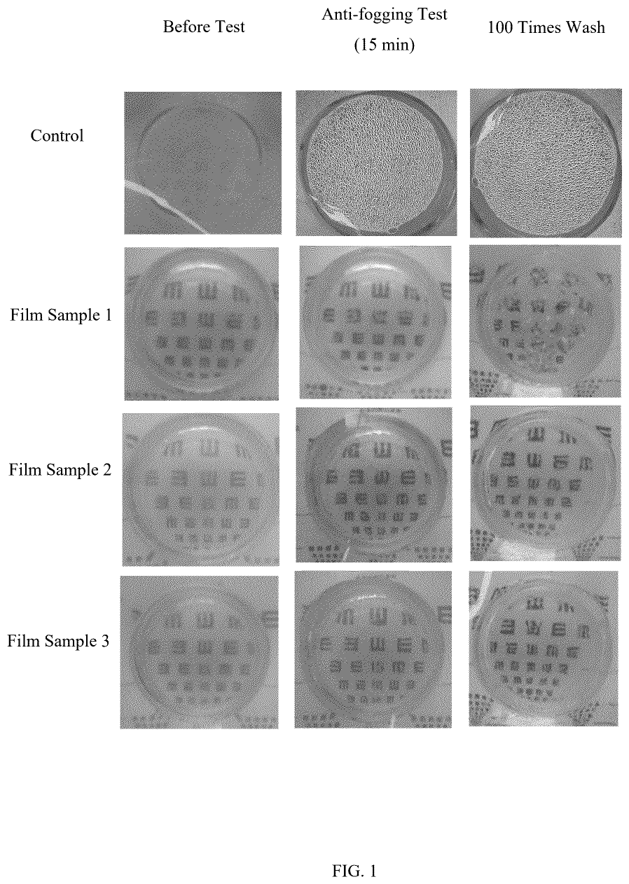

After film making, the anti-fogging performance is tested according to industrial standard guideline GB/T 31726 “Test method for anti-fogging property of plastic film”. The results are displayed in Table 2 and FIG. 1.

TABLE 2

| | Anti-fogging grade | Washability |
|---|---|---|
| AFLSR film sample | (60° C. for 15 mins) | (100 times) |
| Film sample 1 | Grade 2 | Grade 4 |
| Film sample 2 | Grade 2 | Grade 2 |
| Film sample 3 | Grade 1 | Grade 1 |

In summary, film sample 3 shows the best anti-fogging effects, indicating that the adding amount of the liquid silicone rubber additive composition should be less than 5 wt %. The anti-fogging grade of film sample 3 is 2 before washing. The anti-fogging grade of film sample 3 is 2 after 100-time washings. The surface of film sample 3 is transparent and clear with a sharp contrast to the fogging surface on the unmodified control samples after 15 min 60° C. water bath.

The anti-fogging performance of AFLSR origins from the structure formed by the silicone network elastomer and the surfactant. The hydrophilic part, ethylene oxide, of sample 1 (dimethyl siloxane-ethylene oxide block copolymer) reduces the surface tension on the film surface and its hydrophobic part, dimethyl siloxane, provides compatibility with polymer matrix.

The light transmittance which represented transparency was characterized by Haze Meter according to industrial standard guideline GB/T 2410 “Determination of the luminous transmittance and haze of transparent plastics”.

The light transmittance of all AFLSR film sample can achieve above 92.02% with a light transmittance retention up to ˜98% (Table 3). The light transmittance of control LSR is 94.31±0.22%. The high light transmittance retention indicated that the addition of the additive composition would not cause any effect on the transparency of the films.

TABLE 3

| | Light | Light transmittance |
|---|---|---|
| AFLSR film sample | transmittance (%) | retention (%) |
| Control | 94.31 ± 0.22 | — |
| Sample 1 | 92.76 ± 0.26 | 98 |
| Sample 2 | 92.02 ± 0.38 | 98 |
| Sample 3 | 92.55 ± 0.31 | 98 |

The resist bacterial adherence rate of the AFLSR film sample is tested by an accredited third party laboratory according to ASTM E3371 (Standard Test Method for Measuring the Ability of a Synthetic Polymeric Material to Resist Bacterial Adherence). The bacterial adherence rate of the AFLSR film sample, base silicone rubber and polyethylene are quantified according to the degree of bacteria colonization. The bacterial adherence rate of the AFLSR film sample is reduced by 96% for Staphylococcus aureus and 98% for Escherichia coli. (Table 4) This shows that the AFLSR formulation is able to reduce attachment of bacteria to the substrate surface to achieve high bacteria repellency.

TABLE 4

| | | | Average of | | Resist |
|---|---|---|---|---|---|
| | | | logarithm numbers | Resist | Bacterial |
| | | | of culturable | Bacterial | Adherence |
| | Concentration | | bacteria per cm² | Adherence | rate |
| Name of test bacteria | of bacteria | | after | value | (Percent |
| (Strain number) | (CFU/mL) | / | 24 h contact time | (LR) | Reduction %) |
| Staphylococcus aureus | 6.0 × 10⁶ | Treated | 3.9 | 1.4 | 96.0 |
| ATCC 6538 | | specimen | | | |
| | | Untreated | 5.3 | | |
| | | specimen | | | |
| | | Reference | 5.2 | / | |
| | | control | | | |
| | | specimen | | | |
| Escherichia coli | 6.4 × 10⁶ | Treated | 1.4 | 1.7 | 98.0 |
| ATCC 8739 | | specimen | | | |
| | | Untreated | 3.1 | | |
| | | specimen | | | |
| | | Reference | 3.4 | / | |
| | | control | | | |
| | | specimen | | | |

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. An anti-fogging and bacteria-resistant liquid silicone rubber additive composition, comprising:
20-30 wt. % of a silicone network elastomer;
30-70 wt. % of an anti-fogging network-forming surfactant, wherein the anti-fogging network-forming surfactant includes a hydrophilic component comprising hydrophilic groups, and a carbon-based and/or silicone-based hydrophobic component such that the surfactant is capable of integrating with the silicone network elastomer so as to form a partial interpenetrative network; and
4-10 wt. % of a Si—H reactive crosslinker, comprising multiple OH functionality;
wherein the anti-fogging network-forming surfactant is Si—H reactive so as to be crosslinked and enmeshed with the silicone network elastomer by the Si—H reactive crosslinker, forming the partial interpenetrative network.

2. The composition of claim 1, wherein the anti-fogging network-forming surfactant is selected from dimethylsiloxane-ethylene oxide block copolymer, polyglycerol, ethylene oxide or combinations thereof; and the hydrophilic groups are selected from polyhydroxyl group, polyethylene oxide group or combinations thereof.

3. The composition of claim 1, wherein the silicone network elastomer is a silicon or carbon network elastomer crosslinked with polyglycerol chains and/or polyether chains, enhancing the compatibility of the elastomer with a silicone matrix.

4. The composition of claim 3, wherein the silicone network elastomer is to provide a scaffold to capture the anti-fogging network-forming surfactant so that the migration rate of the anti-fogging network-forming surfactant is reduced, achieving a durable anti-fogging effect against washing, rubbing and increased temperature.

5. The composition of claim 3, wherein the silicone network elastomer is selected from cetyl diglyceryl tris(trimethylsiloxy)silylethyl dimethicone, polyglycerin-10, dimethicone (and) dimethicone/polyglycerin-3 crosspolymer, (hydroxypropyleneoxypropyl)methylsiloxane-dimethylsiloxane copolymer, cyclopentasiloxane (and) dimethicone/PEG-10/15 crosspolymer, or polyglyceryl-3 polydimethylsiloxyethyl dimethicone.

6. The composition of claim 1, wherein the Si—H reactive crosslinker is selected from sorbitol, maltitol, isomalt, galactitol, mannitol, xylitol, sucrose, DMPA, PEAE, pentaerythritol, or any combination thereof.

7. A method of preparing the anti-fogging and bacteria-resistant liquid silicone rubber additive composition of claim 1, comprising:
mixing the silicone network elastomer with the anti-fogging network-forming surfactant and the Si—H reactive crosslinker to obtain a mixture;
subjecting the mixture to a reaction process to facilitate crosslinking and incorporation of the components; and
isolating and purifying the resulting anti-fogging and bacteria-resistant liquid silicone rubber additive composition.

8. The method of claim 7, wherein the reaction process comprises heating, stirring, or ultrasonic treatment to ensure thorough mixing and homogeneous distribution of the components within the mixture.

9. A method of fabricating an anti-fogging, antibacterial and transparent liquid silicone-based film, comprising:
adding the anti-fogging and bacteria-resistant liquid silicone rubber additive composition of claim 1 to a transparent liquid silicone elastomer precursor to obtain a mixture;
removing air bubbles from the mixture; and
vulcanizing the mixture for film making to obtain an anti-fogging, antibacterial and transparent liquid silicone-based film;
wherein the step of vulcanizing migrates hydrophilic groups of the hydrophilic component toward the surface of the film to lower the film's surface tension.

10. The method of claim 9, wherein the anti-fogging, antibacterial and transparent liquid silicone rubber film has a bacterial adherence reducing rate ranging from 95% to 99% and possesses food contact safety.

11. The method of claim 9, wherein the surface tension of the film is reduced to that the film has a water contact angle ranging from 60 to 65 degrees.

12. The method of claim 9, wherein the step of vulcanizing is conducted at a temperature ranging from 140 to 250° C. for a duration of 10 seconds to 180 seconds, ensuring optimal cross-linking and incorporation of the anti-fogging network-forming surfactant.

13. A silicone-based film produced using the anti-fogging and bacteria-resistant liquid silicone rubber additive composition of claim 1, wherein the film exhibits durable anti-fogging and antibacterial properties, for high transparency, hygiene, and maintaining visibility.

14. A medical device, food package, or optical lens having the silicone-based film of claim 13 formed thereon.
